(19) United States
(12) Patent Application Publication
(10) Pub. No.: US 2013/0335314 A1
(43) Pub. Date: Dec. 19, 2013

(54) Intelligent Reminding Apparatus and Method Thereof

(71) Applicants: Wen-Yan Chang, Zhunan Township (TW); Tai-Chang Yang, Kaohsiung City (TW); Hong-Long Chou, Taipei City (TW); Chih-Wei Tsai, Tainan City (TW)

(72) Inventors: Wen-Yan Chang, Zhunan Township (TW); Tai-Chang Yang, Kaohsiung City (TW); Hong-Long Chou, Taipei City (TW); Chih-Wei Tsai, Tainan City (TW)

(73) Assignee: ALTEK CORPORATION, Hsinchu (TW)

(21) Appl. No.: 13/599,499

(22) Filed: Aug. 30, 2012

(30) Foreign Application Priority Data
Jun. 18, 2012 (TW) 101121820

(51) Int. Cl. G06F 3/01

(52) U.S. Cl. 345/156

(57) ABSTRACT

An intelligence reminding apparatus and a method thereof. The intelligence reminding method comprises: using an image capturing unit to preview a preview-image or capture a dynamic image; detecting at least one face image of the preview-image or the dynamic image to obtain a face image; recognizing the face image according to a face photo of a database which comprises at least one face photo and at least one corresponding information; acquiring the corresponding information if the face image matches the face photo. Wherein the face recognition is proceeding during the image preview or dynamic image capturing; reminding the corresponding information to users in a display mode, or reminding in a voice mode via a connected earphone or a connected voice apparatus if the connected earphone or the connected voice apparatus is detected.

### CROSS-REFERENCE TO RELATED APPLICATION

This application claims the benefit of Taiwan Patent Application No. 101121820, filed on Jun. 18, 2012, in the Taiwan Intellectual Property Office the disclosure of which is incorporated herein by reference.

### BACKGROUND OF THE INVENTION

The present invention relates to an intelligence reminding apparatus and a method thereof, in particular to the intelligence reminding apparatus and method for performing face detection and recognizing after previewing an image or capturing a dynamic image and comparing the face image in a database to obtain related data in order to determine whether a voice apparatus is detected and decide whether to remind users by image or voice.

In general, people record related reminders on paper or use a mobile phone or a PDA to record the reminders in an electronic form. However, users have to check all of the reminders one by one to find the desired one. Obviously, these methods are tremendously inconvenient to the users.

In addition, after a static image is captured by an image capturing device and a recognition device, the static image is compared with image data saved in a database. If the comparison matches, then related information is linked to provide a reminder of personal calendar or name cards.

However, the prior art still has the drawback of requiring users to take the static image, and thus users have to take the photo face to face with others, and such conduct fails to meet the real time using requirement and is very inconvenient to the users and impolite to take photos in some occasions. Obviously, the prior art emphasizing on taking the photos by the users, which is a big obstacle for the visually impaired persons to use such devices.

In view of the aforementioned drawbacks, it is necessary to provide a reminding apparatus for reminding users with related data of a specific related person actively during the face detection and recognition of the preview-image or the dynamic image.

### SUMMARY OF THE INVENTION

In view of the aforementioned problems of the prior art, it is a primary objective of the present invention to provide an intelligence reminding apparatus and a method thereof to overcome the aforementioned problems.

To achieve the aforementioned objective, the present invention provides an intelligence reminding apparatus comprising an image capturing unit, a face detecting unit, a database, a face recognizing unit and a reminding unit. The image capturing unit is provided for previewing a preview-image or capturing a dynamic image. The face detecting unit is for performing a face detection of the preview-image or the dynamic image to obtain at least one face image. The database, including at least one face photo and at least one history data related to the face photo. The face recognizing unit is provided for comparing the face image with the face photo, and acquiring the history data related to the face photo from the database if the face image matches the face photo, or reminding a user to edit the database to add a communication datum corresponding to the face image if the face image does not match with the face photo, wherein the comparison is performed while previewing the preview-image or after capturing the dynamic image. The reminding unit is provided for performing an image reminding of the history data according to a sequential order after the history data related to the face photo are acquired, wherein if at least one connected earphone or a connected voice apparatus is detected, a voice reminding of the history data is performed by the connected earphone or the connected voice apparatus according to the sequential order.

Wherein, the voice reminding is performed after previewing the preview-image or capturing the dynamic image.

Wherein, the sequential order is related to an identity relation, a communication frequency, a last communication time or a last image capturing time.

Wherein, the image capturing unit is installed onto the connected earphone, a pair of glasses, or a casing of a notebook computer.

Wherein, the image reminding is performed by an externally connected display device when the reminding unit detects the externally connected display device.

To achieve the aforementioned objective, the present invention further provides an intelligence reminding apparatus comprising an image capturing unit, a face detecting unit, a database, a face recognizing unit, a reminding unit and a display unit. The image capturing unit is provided for previewing a preview-image or capturing a dynamic image, and the face detecting unit is provided for performing a face detection of the preview-image or the dynamic image to obtain at least one face image. The database includes at least one face photo and at least one history data related to the face photo. The face recognizing unit is provided for comparing the face image with the face photo, and if the face image matches the face photo, then the history data related to the face photo will be acquired from the database, and if the face image does not match the face photo, then a user will be reminded to edit the database to add a face image and a corresponding communication datum, wherein the comparison is performed while previewing the preview-image or after capturing the dynamic image. The reminding unit is provided for performing an image reminding of the history data on the display unit according to a sequential order after the history data related to the face photo are acquired, wherein if at least one connected earphone or at least one connected voice apparatus is detected, a voice reminding is performed by the connected earphone or the connected voice apparatus according to the sequential order.

Wherein, the image reminding or the voice reminding is performed after previewing the preview-image or capturing the dynamic image.

Wherein, the image capturing unit is installed onto a pair of glasses or a casing of a notebook computer.

To achieve the aforementioned objective, the present invention further provides an intelligence reminding method comprising the following steps: Use an image capturing unit to preview a preview-image or capture a dynamic image. Perform a face detection of the preview-image or the dynamic image to obtain at least one face image. Provide a database including at least one face photo and at least one history data related to the face photo. Compare the face image with the at least one face photo of the database, while previewing the preview-image or after capturing the dynamic image, and acquiring the history data related to the face photo if the face image matches the face photo; or reminding a user to edit the database to add a corresponding face image and a corresponding communication data if the face image does not match with the face photo. Perform an image reminding of the history data according to a sequential order after acquiring the history data related to the face photo, wherein if at least one connected earphone or at least one connected voice apparatus is detected, a voice reminding is performed by the connected earphone or the connected voice apparatus according to the sequential order.

Wherein, the intelligence reminding method of the present invention further comprises the step of performing the image reminding or the voice reminding after previewing the preview-image or capturing the dynamic image.

Wherein, the sequential order is related to an identity relation, a communication frequency, a last communication time or a last image capturing time.

In summation, the present invention has the following advantages: The active reminding apparatus is for performing a face detection and confirming an identity through a mobile phone, a camera, or a wearing type image capturing system during the process of previewing an interlocutor's image or capturing the interlocutor's dynamic image, and looking up a related working item list, a key reminder and important short messages automatically according to the identity data, and finally displaying these data on a screen of a handheld device screen, or reminding the users by a voice by a wireless earphone via a wireless transmission.

In addition, this function can be used as an auxiliary tool for the visually impaired persons, since the mobile phone, camera, or wearing type image capturing device can recognize the image quickly and remind the user through voices about the identity information of a person to facilitate the social activities of the visually impaired persons.

The advantages and spirit of the present invention will become apparent with the detailed description of preferred embodiments accompanied with the illustration of related drawings as follows.

### BRIEF DESCRIPTION OF THE DRAWINGS

FIG. 1 is a block diagram of an intelligence reminding apparatus of the present invention;

FIG. 2 is a flow chart of an intelligence reminding method of the present invention;

FIGS. 3A and 3B are schematic views of an intelligence reminding apparatus of a first preferred embodiment of the present invention;

FIG. 4 is a schematic view of an intelligence reminding apparatus of a second preferred embodiment of the present invention;

FIGS. 5A and 5B are schematic views of an intelligence reminding apparatus of a third preferred embodiment of the present invention; and

FIGS. 6A and 6B are schematic views of an intelligence reminding apparatus of a fourth preferred embodiment of the present invention.

### DESCRIPTION OF THE PREFERRED EMBODIMENTS

The technical contents and characteristics of the present invention will be apparent with the detailed description of a preferred embodiment accompanied with related drawings as follows. For simplicity, the drawings are not necessarily drawn in actual scale or ratio, and same numerals are used in the following preferred embodiment to represent respective same elements. It is noteworthy that the drawings are provided for the purpose of illustrating the present invention, but not intended for limiting the scope of the invention.

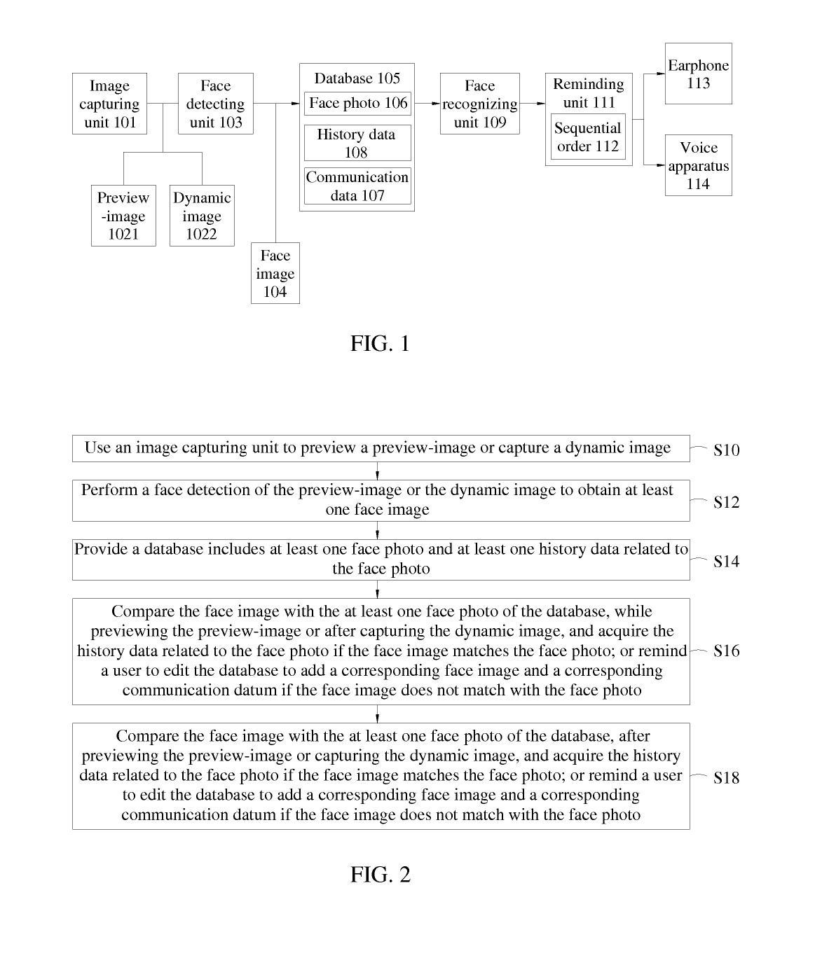

With reference to FIG. 1 for a block diagram of an intelligence reminding apparatus of the present invention, the intelligence reminding apparatus comprises:

an image capturing unit 101, a face detecting unit 103, a database 105, a face recognizing unit 109 and a reminding unit 111. The database 105 includes at least one face photo 106 and at least one history datum 108 related to the face photo 106. The history data 108 may include a name, an identity relation, a communication record, a working item list, a short message datum, a last meeting time, and/or a last image capturing time. The image capturing unit 101 is provided for previewing a preview-image 1021 or capturing a dynamic image 1022, and then the face detecting unit 103 performs a face detection of the preview-image 1021 or the dynamic image 1022 to obtain at least one face image 104. And then, the face recognizing unit 109 compares the face image 104 with a face photo 106 saved in the database 105 while previewing the preview-image 1021 or after capturing the dynamic image 1022. If the face image 104 matches the face photo 106, then the history data 108 related to the face photo 106 will be acquired from the database 105. If the face image 104 does not match any face photo 106 saved in the database 105, then the user will be reminded to edit the database 105 to add a face image 104 and communication data 107 and history data 108 corresponding to the face image 104.

After the reminding unit 111 acquiring the history data 108 related to the face photo 106, the history data 108 are reminded after previewing the preview-image 1021 or capturing the dynamic image 1022 according to a sequential order 112, wherein if the reminding unit 111 detects at least one connected earphone 113 or a connected voice apparatus 114, then a voice reminding will be performed according to the sequential order 112 by the connected earphone 113 or the connected voice apparatus 114 after previewing the preview-image 1021 or capturing the dynamic image 1022. Wherein, the sequential order 112 is related to an identity relation, a communication frequency, a last communication time, and a last image capturing time.

The working principle of the intelligence reminding apparatus of the present invention is shown in FIGS. 1, 2 and 4 and described as follows.

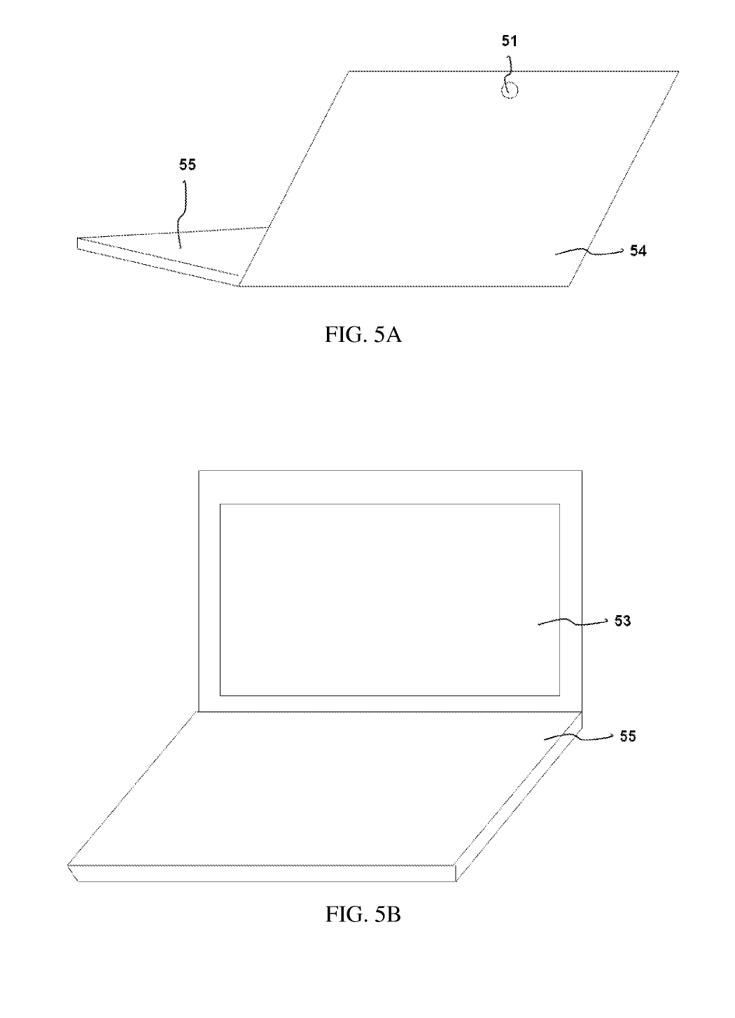

In a preferred embodiment of the present invention, the intelligence reminding apparatus may be a built-in connected earphone with an image capturing function as shown in FIG. 4. In FIG. 4, the connected earphone 41 includes a camera lens 43 installed thereon for capturing images, and an earphone user is situated on the opposite side of a person, so that the earphone user can use the camera lens 43 installed on the earphone to preview a preview-image 1021 in front of the person, and the face detecting unit 103 performs a face detection of the preview-image 1021 to obtain at least one face image 104. And then, the face recognizing unit 109 compares the face image 104 of the preview-image 1021 with a face photo 106 saved in a database 105 of the earphone when previewing the preview-image 1021. If the face image 104 matches the face photo 106, then history data 108 related to the face photo 106 such as a person's name, an identity relation with the person, past communication records, a working item list, a short message data, the last meeting time or the last image capturing time are acquired from the database 105. If the face image 104 does not match the face photo 106, and the generation of a comparison result fails, then the user will be reminded to capture the face image 104 of the person to add a face photo 106 and history data 108 of the person, and the user can press the image capturing button of the earphone to capture a dynamic image 1022 and add the face photo 106 and history data 108 such as the related interactive conversations. After the reminding unit 111 built in the connected earphone 41 obtaining the history data 108 related to the face photo 106, a sequential order 112 of the history data 108 related to the face photo 106 is determined according to the character, the identity relation with the user, the communication frequency, the last communication time or the last image capturing time shown on the preview screen, so as to perform a voice reminding of the history data 108 by the connected earphone 41 when the camera lens of the earphone previewing the preview-image 1021.

The working principle of an intelligence reminding apparatus in accordance with another preferred embodiment of the present invention is shown in FIGS. 1, 2, 3A and 3B and described as follows.

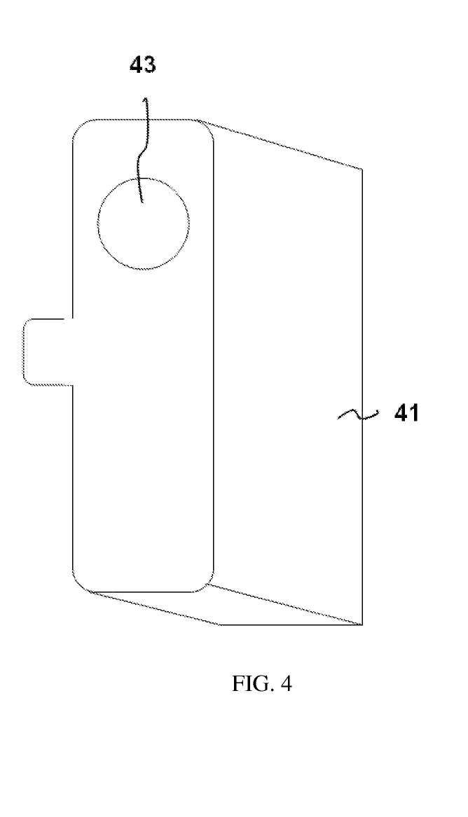

With reference to FIGS. 3A and 3B for another preferred embodiment of the present invention, the intelligence reminding apparatus may be a pair of glasses with an image capturing function. In this preferred embodiment, an image capturing unit 33 is installed onto a pair of glasses 31, so that a user can capture, recognize and remind a face image of a person in front of the user through the intelligence device of the pair of glasses. The user can use the image capturing unit 33 installed on the pair of glasses 31 to preview a preview-image 1021, and the face detecting unit 103 to perform a face detection of the preview-image 1021 or a dynamic image 1022 to obtain at least one face image 104. And then, a face recognizing unit 109 is provided for comparing the face image 104 with a face photo 106 saved in the database 105 while previewing the preview-image 1021. If a comparison result between the face image 104 and the face photo 106 can be generated, then the history data 108 related to the face photo 106 will be acquired from the database 105. After the reminding unit 111 acquiring the history data 108 related to the face photo 106, a identity relation, a communication frequency, a last communication time or a last image capturing time can be used to determined a sequential order of the aforementioned history data 108 provided while a power supply 214 of a connected earphone 215 is detected to be powered on. While the preview-image 1021 is being previewed, the connected earphone 215 performs a voice reminding at the same time. If the user does not want to be reminded by the voice reminding, the user can turn off the power supply 214 of the earphone. If the power supply 214 of the earphone is turned off, and the reminding unit 111 detects that the user is using a connected smartphone 211, then a screen 212 of the phone will display the history data in a sequential order determined according to the identity relation, the communication frequency, the last communication time or the last image capturing time, and an image reminding can be performed to the user.

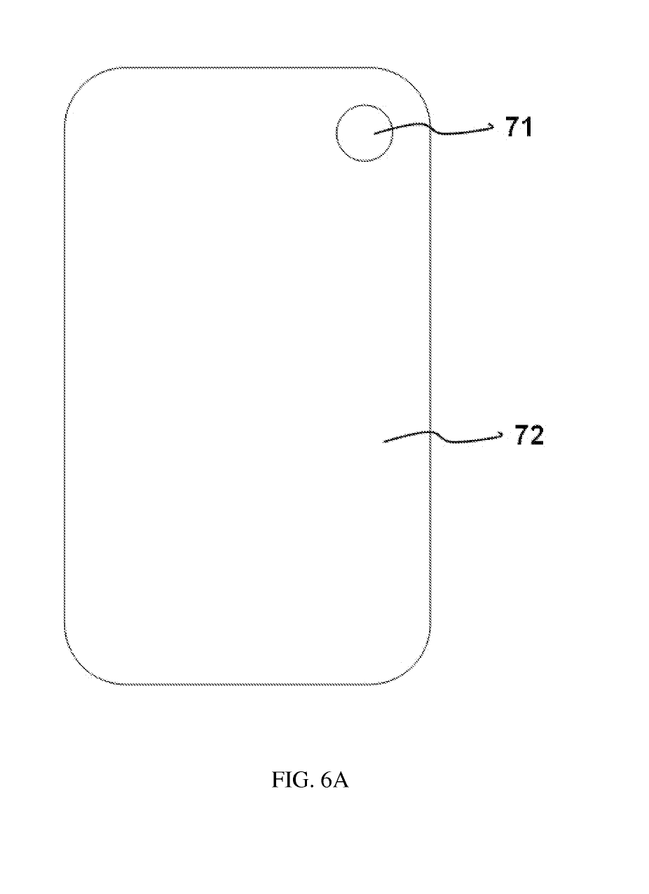

With reference to FIGS. 5A and 5B for a further preferred embodiment of the present invention, the intelligence reminding apparatus of this embodiment is used in a notebook computer 55, and the operating principle of the intelligence reminding apparatus is shown in FIGS. 1, 5A and 5B. In FIG. 5A, a camera lens 51 is installed on an outer side 54 of a casing of the notebook computer 55, so that when a user turns on the notebook computer 55, the camera lens 51 installed on the outer side 54 of the casing can capture successive dynamic images of a person in front of the user. After the user has captured the dynamic image 1022 on an opposite side through the camera lens 5, the face detecting unit 103 performs a face detection of the dynamic image 1022 to obtain at least one face image 104. And then, a face recognizing unit 109 compares a face image 104 with a face photo 106 saved in a database 105. If the face image 104 matches the face photo 106, then history data 108 related to the face photo 106 includes a name, an identity relation, a communication record, a working item list, a last meeting time or a last image capturing time are acquired from the database 105. If any comparison result between the face image 104 and the face photo 106 fail to be generated, the user will be reminded to update the face photo 106 saved in database 105 with the most recently captured dynamic image 1022. If the person is a new acquaintance, then the user can add the most recently captured dynamic image 1022 to update the face photo 106 of the database 105 and add history data 108 corresponding to the face photo 106 such as a communication data 107, a name, an identity relation, a communication record, a working item list, a last meeting time, or a last image capturing time as a reference for the sequential order of data reminding. After the reminding unit 111 has acquired the history data 108 related to the face photo 106, a screen 53 of a notebook computer 55 is provided for displaying the related information of the identity relation, the communication frequency, the last communication time, the last image capturing time in a sequential order 112 according to the face image 104 and reminding the user about the history data. In other words, if the user is having a meeting, the reminding unit 111 can determine whether the opposite party is a co-worker of the user based on the identity relation, so as to arrange a work item list, a short message, or a mail of the recent communication to a higher priority level.

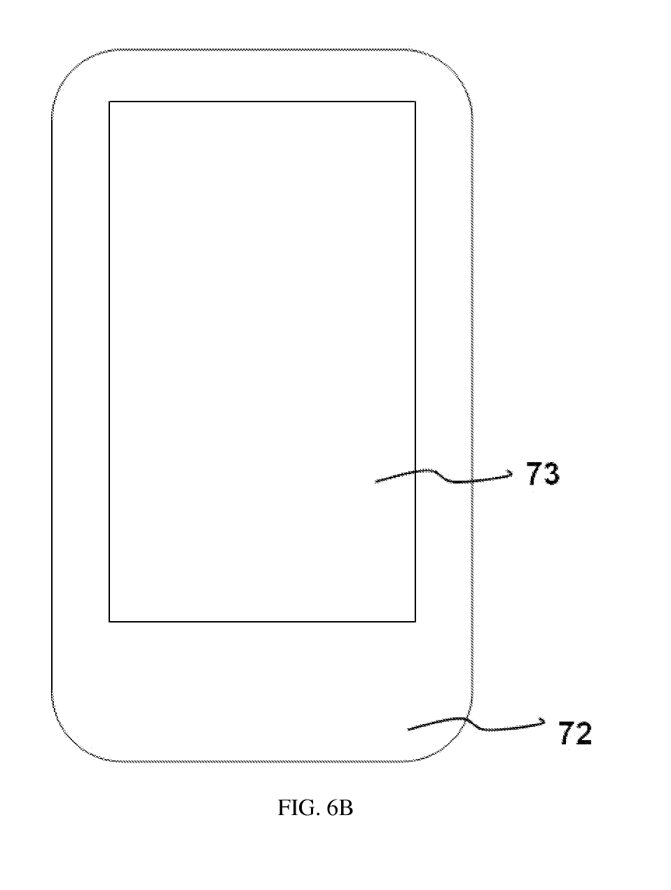

With reference to FIGS. 6A and 6B for a further preferred embodiment of the present invention, the intelligence reminding apparatus of this embodiment is a smartphone with a display unit, and the operating principle is illustrated in FIGS. 1, 4, 6A and 6B. In FIG. 6B, the smartphone 72 has a screen 73 acting as the display unit. In FIG. 6A, the smartphone 72 has a camera lens 71 installed on the rear side of a casing, so that a user can capture a dynamic image 1022 of a person in front of the user. After the dynamic image 1022 is captured, a face detecting unit 103 performs a face detection of the dynamic image 1022 to obtain at least one face image 104. A database 105 of the smartphone 72 includes at least one face photo 106 and at least one history data 108 related to the face photo 106. A face recognizing unit 109 is provided for comparing the face image 104 with a face photo 106. If the face image 104 matches the face photo 106, then history data 108 related to the face photo 106 including a character's name, an identity relation, a communication record, a working item list, a short message datum, a last meeting time or a last image capturing time will be acquired from the database 105. If the face image 104 does not match the face photo 106, then the screen 73 will remind the user to edit the database 105 to add a face image 104 and a corresponding communication data 107. After the reminding unit 111 acquiring the history data 108 related to the face photo 106, the aforementioned history data 108 are displayed on the screen 73 in a sequential order 112 according to the identity relation, the communication frequency, the last communication time, and the last image capturing time. If the smartphone 72 detects that itself is connected with an earphone 41, a voice reminding can be performed to the user by the connected earphone 41 based on the sequence.

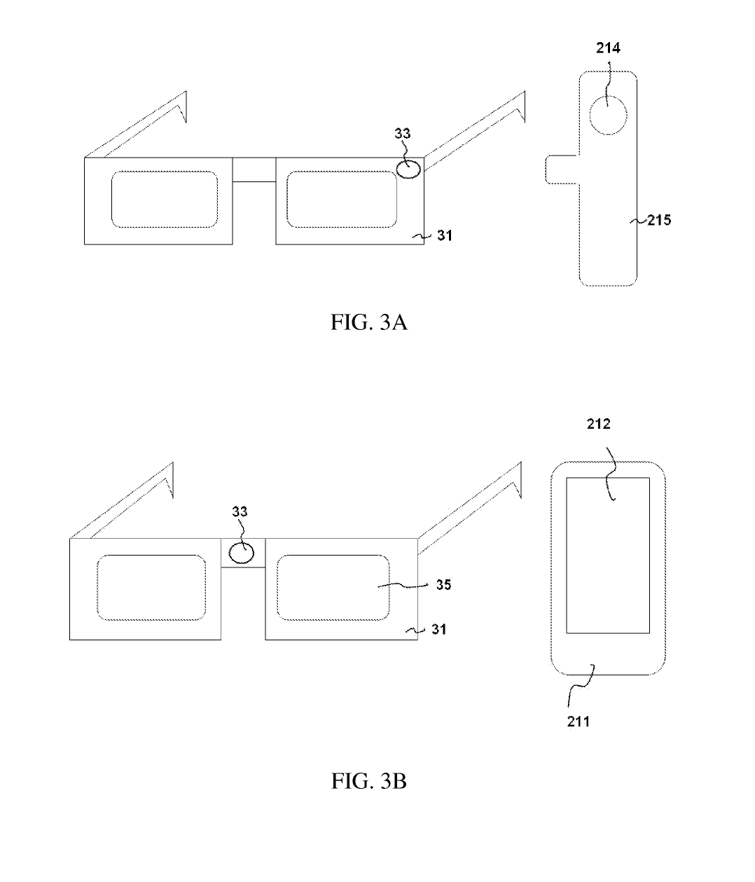

With reference to FIG. 2 for a flow chart of an intelligence reminding method of the present invention, the intelligence reminding method comprises the following steps:

S10: Use an image capturing unit to preview a preview-image or capture a dynamic image.

S12: Perform a face detection of the preview-image or the dynamic image to obtain at least one face image.

S14: Provide a database including at least one face photo and at least one history data related to the face photo.

S16: Compare the face image with the at least one face photo of the database, while previewing the preview-image or after capturing the dynamic image, and acquire the history data related to the face photo if the face image matches the face photo; or remind a user to edit the database to add a corresponding face image and a corresponding communication datum if the face image does not match with the face photo.

S18: Perform an image reminding of the history data according to a sequential order after acquiring the history data related to the face photo, wherein if at least one connected earphone or a connected voice apparatus is detected, a voice reminding is performed by the connected earphone or the connected voice apparatus according to the sequential order.

While the invention has been described by means of specific embodiments, numerous modifications and variations could be made thereto by those skilled in the art without departing from the scope and spirit of the invention set forth in the claims.

What is claimed is:

1. An intelligence reminding apparatus, comprising:
an image capturing unit, for previewing a preview-image or capturing a dynamic image;
a face detecting unit, for performing a face detection of the preview-image or the dynamic image to obtain at least one face image;
a database, including at least one face photo and at least one history data related to the face photo;
a face recognizing unit, for comparing the face image with the face photo, and acquiring the history data related to the face photo from the database if the face image matches the face photo, or reminding a user to edit the database to add a communication data corresponding to the face image if the face image does not match with the face photo; wherein the comparison is performed while previewing the preview-image or after capturing the dynamic image; and
a reminding unit, for performing an image reminding of the history data according to a sequential order after the history data related to the face photo are acquired, wherein if at least one earphone or at least one voice apparatus is detected, a voice reminding of the history data is performed by the connected earphone or the connected voice apparatus according to the sequential order.

2. The intelligence reminding apparatus of claim 1, wherein the voice reminding is performed when previewing the preview-image or capturing the dynamic image.

3. The intelligence reminding apparatus of claim 1, wherein the sequential order is related to an identity relation, a communication frequency, a last communication time or a last image capturing time.

4. The intelligence reminding apparatus of claim 1, wherein the image capturing unit is installed onto the earphone, a pair of glasses, or a casing of a notebook computer.

5. The intelligence reminding apparatus of claim 1, wherein the image reminding is performed by an externally connected display device when the reminding unit detects the externally connected display device.

6. An intelligence reminding apparatus with a display unit, comprising:
an image capturing unit, for previewing a preview-image or capturing a dynamic image;
a face detecting unit, for performing a face detection of the preview-image or the dynamic image to obtain at least one face image;
a database, including at least one face photo and at least one history data related to the face photo;
a face recognizing unit, for comparing the face image with the face photo, and acquiring the history data related to the face photo from the database if the face image matches the face photo, or reminding a user to edit the database to add a communication data corresponding to the face image if the face image does not match with the face photo; wherein the comparison is performed while previewing the preview-image or after capturing the dynamic image; and
a reminding unit, for performing an image reminding of the history data on the display unit according to a sequential order after the history data related to the face photo are acquired, wherein if at least one earphone or a voice apparatus is detected, a voice reminding is performed by the earphone or the voice apparatus according to the sequential order.

7. The intelligence reminding apparatus with a display unit according to claim 6, wherein the image reminding or the voice reminding is performed after previewing the preview-image or capturing the dynamic image.

8. The intelligence reminding apparatus with a display unit according to claim 6, wherein the image capturing unit is installed onto a pair of glasses or a casing of a notebook computer.

9. An intelligence reminding method, comprising the steps of:
using an image capturing unit to preview a preview-image or capture a dynamic image;
performing a face detection of the preview-image or the dynamic image to obtain at least one face image;
providing a database including at least one face photo and at least one history data related to the face photo;
comparing the face image with the at least one face photo of the database, while previewing the preview-image or after capturing the dynamic image, and acquiring the history data related to the face photo if the face image matches the face photo; or reminding a user to edit the database to add a corresponding face image and a corresponding communication datum if the face image does not match with the face photo; and
performing an image reminding of the history data according to a sequential order, after acquiring the history data related to the face photo, wherein if at least one earphone or a voice apparatus is detected, a voice reminding is performed by the earphone or the voice apparatus according to the sequential order.

10. The intelligence reminding method of claim 9, further comprising the step of performing the image reminding or the voice reminding after previewing the preview-image or capturing the dynamic image.

11. The intelligence reminding method of claim 9, wherein the sequential order is related to an identity relation, a communication frequency, a last communication time or a last image capturing time.
